(19) United States
(12) Patent Application Publication
(10) Pub. No.: US 2023/0015566 A1
(43) Pub. Date: Jan. 19, 2023

(54) WIND GENERATOR HAVING A HORIZONTAL ROTATING AXIS FOR THE PRODUCTION OF ELECTRIC ENERGY PROVIDING POWER SUPPLY AND PROPULSION OF ELECTRIC TRANSPORTATION MEANS

(71) Applicant: Turbo Power System S.r.l., Rome (IT)

(72) Inventors: Aldo Fava, Montalto di Castro (IT); Zivana Bembic, Montalto di Castro (IT)

(21) Appl. No.: 17/784,993

(22) PCT Filed: Dec. 19, 2019
(86) PCT No.: PCT/IT2019/000119

§ 371 Date: Jun. 13, 2022

(51) Int. Cl. F03D 9/25; F03D 1/04; F03D 9/32; H02K 7/08; H02K 7/18

(52) U.S. Cl. CPC F03D 9/25; F03D 1/04; F03D 9/32; H02K 7/083; H02K 7/183

(57) ABSTRACT

Wind generator (100) having a horizontal axis, installed in electric transportation means that can be of different types, as: car vehicles, motor vehicles, rail vehicles, water vehicles and air vehicles; said wind generator (100) comprising: —an air conveyor, called shell (101), having a cylindrical shape that is empty inside, having some openings on the outer surface, so called oval-shaped nozzles (104a, 104b, . . . ); —a horizontal wind turbine (107), comprising a rotary group of wind blades (112a, 112b, . . . ) fixed to a union ogive (116); —a transmission axis (109), being rotating and horizontal, where said turbine (107) is installed with its respective ogive (116) placed at the front part of said axis (109) and where an electric generator (102) is installed at the rear part of said axis (109), through a rotary element of said electric generator (102), so that a rotation of turbine (107) is transmitted, through a rotation of axis (109), to the rotary element of the electric generator (102); —said electric generator (102), comprising said rotary element and a fixed element, that is connected to the wind turbine (107) through the transmission axis (109); the electric generator (102) is further connected, by using electric cables (105), to some external electric accumulators; —at least two ball bearings (108, 111) anchoring, through connection elements, said rotary transmission axis (109) together either with the wind turbine (107) and the electric generator (102), in a stable position inside said shell (101), at the same time allowing the rotary motion of said rotating axis (109) on itself; —a cover (103) closing the rear part of said shell (101); —at least two supporting elements (106, 110) placed on the outer surface of said shell (101), in order to achieve an anchorage of the wind generator (100) to the transportation means on which it is installed, so that an air flow coming from the front part of said wind generator (100), having impact on said blades (112a, 112b, . . . ), forces said transmission axis (109) to a rotary motion and therefore forces the rotary element of the electric generator (102) to a rotary motion, generating therefore electric energy that can be immediately transmitted to an electric engine and/or other devices belonging to the transportation means, otherwise the electric energy can be saved into said accumulators, characterized in that: —said wind blades (112a, 112b, . . . ) are bent, shaped and welded to said ogive (116), and they have a helical convex shape with the external profile inclined towards the inside of the turbine (107).

The present invention regards the field of renewable energy, and related applications to the transportation means, and more precisely the achievement of a wind turbine having a horizontal axis, characterized by a significant power to transform the friction air to electricity.

The wind generator is composed of an air conveyor, a wind turbine and an electric generator, and by installing it in the front part of a moving vehicle, the friction air permits to generate electricity. By increasing the vehicle speed, and therefore the kinetic impact power, it happens as a consequence that the wind turbine connected to the electric generator increases the power of energy exchange in the accumulators.

The present invention increases constantly the amount of energy available to the standard batteries of electric transportation means, by improving the autonomy in the long and short travels, avoiding uncomfortable stops to recharge the batteries.

However, the objective of the present invention is to produce clean energy at zero cost, in order to increase the market of the electric transportation vehicles.

The wind generator can be installed on: bicycles, motorbikes, car vehicles, trucks, trains, flying vehicles, etc. Surely in the near future some transportation means, as in example big trucks, buses, trains and flying vehicles, should be improved by including a system for conversion of friction air to clean energy like the above described one. The present invention is a revolutionary innovative solution to increase the development of the electric transportation market at zero cost, by creating a specific field in the international market of green economy.

As known, different types of wind generators, having a horizontal axis, are available from the state of the art. Usually, they are applied to the production of electric energy to be transmitted to the electric network of the national provider, but they are not applied to propulsion pr power supply of motors or systems installed on transportation means, as in example: car vehicles, motor vehicles, bicycles, rail vehicles, water vehicles, air vehicles, etc.

Some technical problems are solved by some of the known generators: in example, some of them solve the problem of interruption in the generation of energy by using a double horizontal axis. Some other wind generators known from the art disclose solutions in the technical-constructive features of the turbines, or of the horizontal or vertical axis, singularly or in combination each other. Some other systems include some specific electronics in order to increase the performance in the rotary motion.

However, there are still some important drawbacks in the application of wind generators to motors or to power supply of transportation means:
the transformation of kinetic energy, generated by friction of air on the outer surfaces of a mean, requires complex and precise electronic control equipment, that does not allow to achieve simple systems for the generation of electric energy to be used for propulsion of means;
considering the speed of vehicles (and similar transportation means) that is highly variable, the wind generators for production of electric energy are not used in order to power supply electric motors or other devices on the same means;
usually, some systems for generation of electric energy can be applied to the transportation means, and the systems have as a source of energy: the motion of the wheels in the same means; the internal combustion engine (oil, diesel, gas, etc.), as in case of means having a hybrid supply; other processes as the friction of brakes on the wheels, or that generated by the contact on surfaces; or additional sources;
in all the above cases, it is not possible to avoid a lack in production and saving of energy, due to the non continuous use of said devices or systems, with a consequence not efficient process of production of electric energy; and that probably represents the worst drawback of a wind generator having a horizontal axis.

Therefore, the present invention overcomes all the drawbacks of the solutions disclosed from the prior art, and the main objective is to propose a wind generator for transformation of kinetic energy of an air flow, moving in respect to the outer surface of transportation means, to kinetic energy of a rotating wind turbine having a horizontal axis, leading to a consequent transformation of kinetic energy to electric energy, by using an electric generator; the energy produced is available either to save electric energy (in batteries) and to provide propulsion of means (electric engines).

Another objective is that the device is composed of an innovative combination of:
some elements that are known from the state of the art, being of common use on the market: air conveyor or shell; ogive; electric generator; electric accumulator; electric connecting cables; anchorage supports,
and innovative and original elements: air conveyor comprising oval-shaped nozzles; turbine having a rotary horizontal axis; an innovative shape and conformation of the wind turbine blades; their innovative combination.

Another further objective is the generation of a constant, continuous and potentially unlimited energy; the impact of air on the turbine that has been properly installed on the outer surface of the transportation mean (car vehicle, motor vehicle, bicycle, rail vehicle, water vehicle, air vehicle, etc.), by penetration of air into the air conveyor, causes a rotary motion of the turbine blades, producing a constant kinetic energy, that is transmitted to an electric generator, installed at the rear part of the general device.

Another objective is to avoid the problem of interruption, discontinuity and insufficient production of energy, considering that the constant friction of air generated by the vehicle in motion activates the turbine according to a force that is proportional to the speed of the vehicle, and at the same time permits to achieve a significant energetic autonomy, either in propulsion and for other electric and/or electronic systems necessary for a proper functioning;

Another further objective is that the turbine presents a particular design and shape, and a strength of materials used to be constructed, so that to achieve a generation of kinetic energy as an effect of the rotary motion of the blades; in fact the efficiency of energy production in the wind generator depends on the characteristics in the turbine and, in particular, on the technical specifications of the blades belonging to the same turbine.

Therefore, it is specific subject of the present invention a wind generator having a horizontal axis, installed in electric transportation means that can be of different types, as: car vehicles, motor vehicles, rail vehicles, water vehicles and air vehicles; said wind generator comprising:
an air conveyor, called shell, having a cylindrical shape that is empty inside, having some openings on the outer surface, so called oval-shaped nozzles;
a horizontal wind turbine, comprising a rotary group of wind blades fixed to a union ogive;
a transmission axis, being rotating and horizontal, where said turbine is installed with its respective ogive placed at the front part of said axis and where an electric generator is installed at the rear part of said axis, through a rotary element of said electric generator, so that a rotation of turbine is transmitted, through a rotation of axis, to the rotary element of the electric generator;
said electric generator, comprising said rotary element and a fixed element, that is connected to the wind turbine through the transmission axis; the electric generator is further connected, by using electric cables, to some external electric accumulators;
at least two ball bearings anchoring, through connection elements, said rotary transmission axis together either with the wind turbine and the electric generator, in a stable position inside said shell, at the same time allowing the rotary motion of said rotating axis on itself;
a cover closing the rear part of said shell;
at least two supporting elements placed on the outer surface of said shell, in order to achieve an anchorage of the wind generator to the transportation means on which it is installed,

so that an air flow coming from the front part of said wind generator, having impact on said blades, forces said transmission axis to a rotary motion and therefore forces the rotary element of the electric generator to a rotary motion, generating therefore electric energy that can be immediately transmitted to an electric engine and/or other devices belonging to the transportation means, otherwise the electric energy can be saved into said accumulators,

characterized in that:
said wind blades are bent, shaped and welded to said ogive, and they have a helical convex shape with the external profile inclined towards the inside of the turbine.

The present invention, when compared to similar known devices, is characterized by a series of further advantages, as in example:
it permits to produce energy from renewable sources, without any emissions and/or pollution;
it permits to produce energy even at slow velocity of the vehicle on which it is installed;
it permits a significant decrease of costs: a “zero-cost” energy;
it allows the use of electric propulsion engines using a clean energy;
it develops and increases the market of clean energy, according to the concept of smart city.

The present invention is now being described according to non-limiting examples, with particular reference to the figures of the enclosed drawings, where:

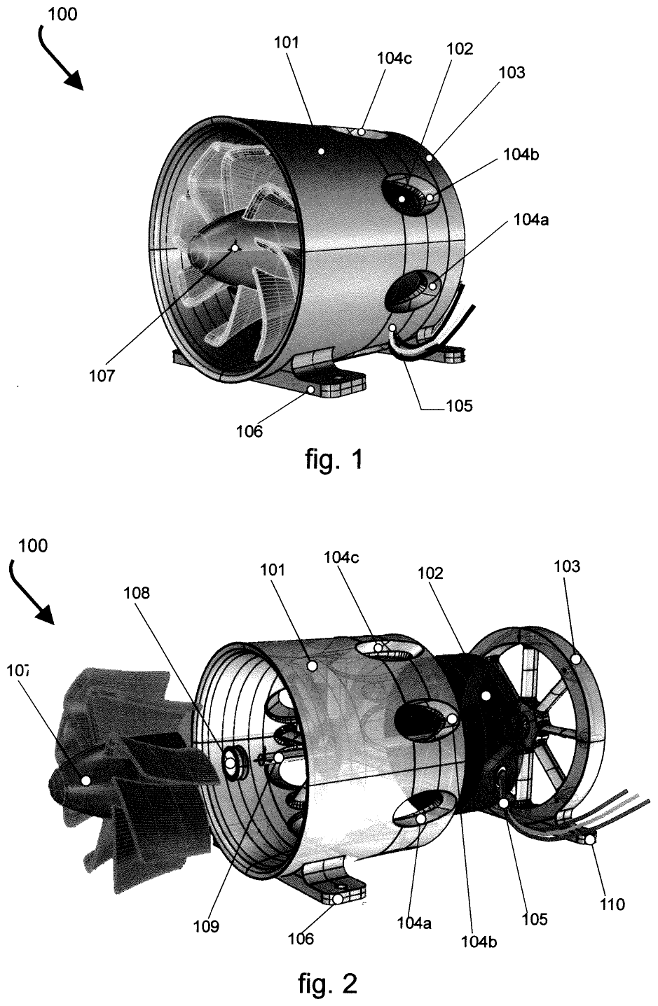

FIG. 1 is a front/right perspective view of a wind generator according to the present invention, in an assembled configuration;

FIG. 2 is a front/right perspective view of the same wind generator of FIG. 1, in a disassembled configuration where the single components are visualized in detail;

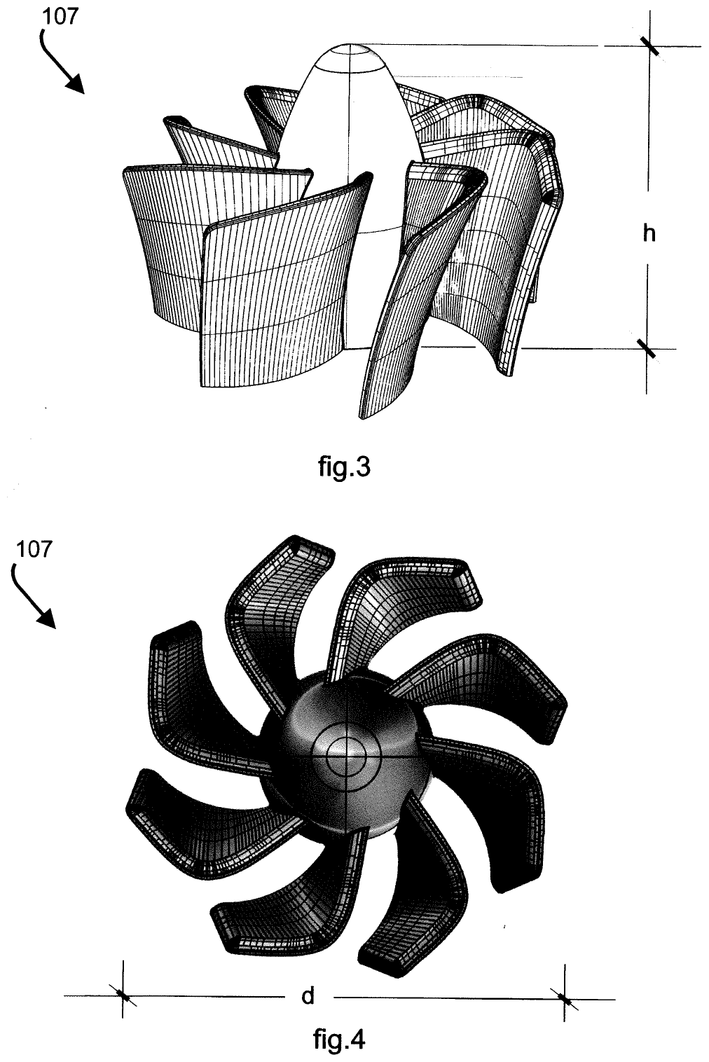

FIG. 3 is a top perspective view of a single component of the generator of FIG. 1, represented by a wind turbine;

FIG. 4 is a front view of the same wind turbine of FIG. 3;

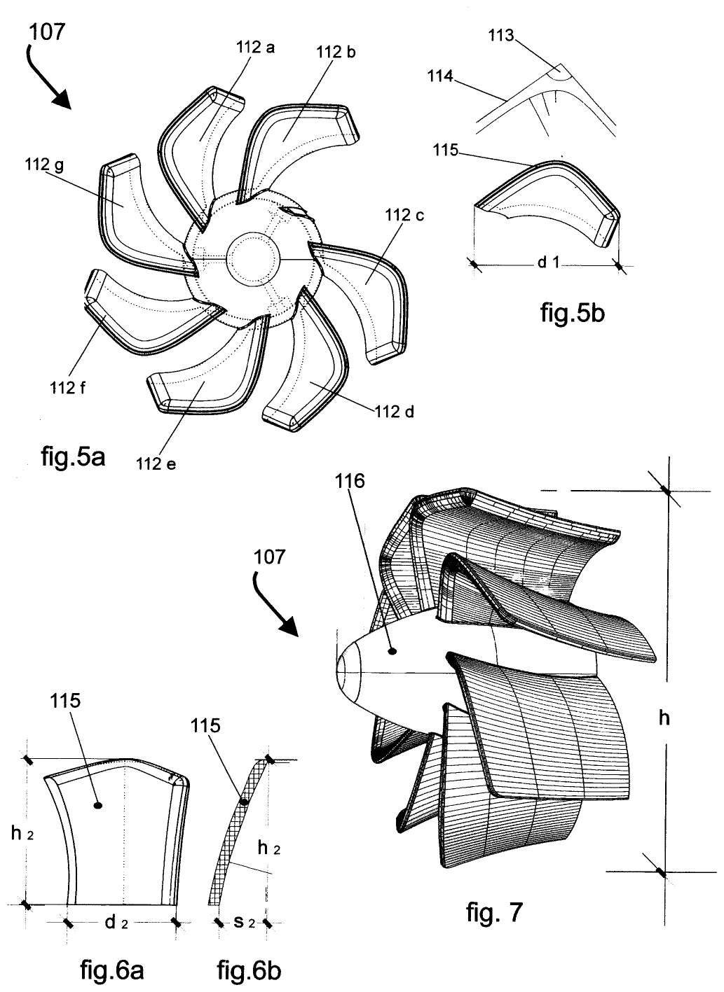

FIGS. 5a and 5b are respective front views of the same wind turbine of FIGS. 3 and 4, with details of the blades, measures and angles;

FIGS. 6a and 6b are respective front and lateral views of details of one of the blades, belonging to the same wind turbine of FIGS. 3 and 4;

FIG. 7 is a lateral perspective view of the same wind turbine of FIGS. 3 and 4;

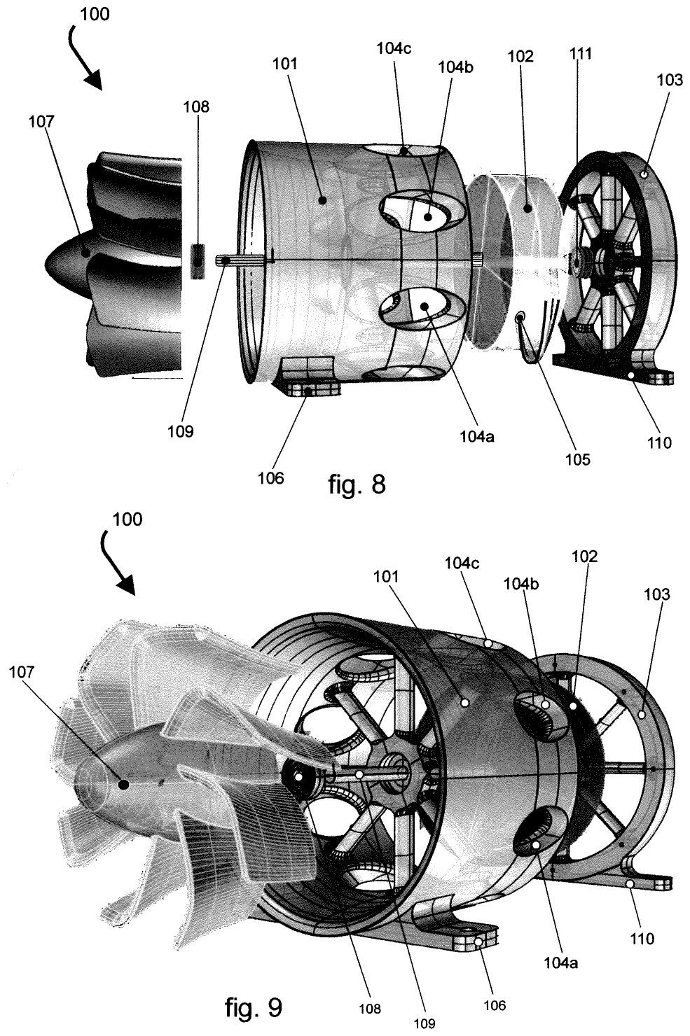

FIG. 8 is a lateral perspective view of the same wind turbine of FIG. 1, in a disassembled configuration where the single components are shown in detail;

FIG. 9 is a front/right perspective view of the same wind turbine of FIG. 1, in a disassembled configuration where the single components are shown in detail.

It is underlined that only few of the many conceivable embodiments of the present invention are here described, which are just some specific non-limiting examples, having the possibility to describe many other embodiments based on the disclosed technical solutions of the present invention.

FIGS. 1, 2, 8 and 9 show a wind generator 100, having a horizontal axis, according to the present invention. It can be installed in electric transportation means that can be of different types, as: car vehicles, motor vehicles, rail vehicles, water vehicles and air vehicles.

The wind generator 100 comprises an air conveyor 101 inside which all the other main components are contained, represented by a horizontal wind turbine 107 connected to a transmission axis 109, that is connected in turn to an electric generator 102.

The air conveyor, called shell 101, has a cylindrical shape that is empty inside, having some openings on the outer surface, so called oval-shaped nozzles 104a, 104b, . . . .

The air conveyor 101 includes said oval-shaped nozzles 104a, 104b, . . . , having a two dimensional shape that is elliptical and three dimensional conic, that can have different number and size, and can be placed in different positions according to specific needs.

Inside the conveyor 101, approximately in the middle of its cylindric surface, an element is installed, having 8 arms, that supports a central cylinder, inside which said horizontal rotary axis 109 with turbine 107 is installed.

The horizontal wind turbine 107 comprises a rotary group of wind blades 112a, 112b, . . . , fixed to a union ogive 116.

The transmission axis 109 is rotating and horizontal, where said turbine 107 is installed with its respective ogive 116 placed at the front part of said axis 109 and where an electric generator 102 is installed at the rear part of said axis 109, through a rotary element of said electric generator 102, so that a rotation of turbine 107 is transmitted, through a rotation of axis 109, to the rotary element of the electric generator 102.

The electric generator 102, comprises a rotary element and a fixed element, that is connected to the wind turbine 107 through the transmission axis 109; the electric generator 102 is further connected, by using electric cables 105, to some external electric accumulators.

The wind generator 100 further comprises at least two ball bearings 108, 111, anchoring, through connection elements, said rotary transmission axis 109 together either with the wind turbine 107 and the electric generator 102, in a stable position inside said shell 101, at the same time allowing the rotary motion of said rotating axis 109 on itself.

The wind generator 100 further comprises a cover 103 closing the rear part of said shell 101, and at least two supporting elements 106, 110, placed on the outer surface of said shell 101, in order to achieve an anchorage of the wind generator 100 to the transportation means on which it is installed.

In such a way, an air flow coming from the front part of said wind generator 100, having impact on said blades 112a, 112b, . . . , forces said transmission axis 109 to a rotary motion and therefore forces the rotary element of the electric generator 102 to a rotary motion, generating therefore electric energy that can be immediately transmitted to an electric engine and/or other devices belonging to the transportation means, otherwise the electric energy can be saved into said accumulators.

The air conveyor 101 has a cylindrical shape empty inside, and it has a front opening having a diameter that is larger in respect to the rear opening, therefore the air conveyor 101 presents a cone-shaped lateral surface, having a profile decreasing in size from the front part to the rear part. The wind blades 112a, 112b, . . . , have their outer profile bended towards the inside of the turbine 107, with their rotary motion create a path for the air entering into the generator 100 that rotate on itself as a spiral in the longitudinal direction.

In such a way, the air flowing as a spiral, inside the generator 100, bounded by the lateral surface of the air conveyor 107, going ahead on its path it is pressed along smaller spaces, increasing the inner pressure and therefore the force on the wind blades 112a, 112b, . . . , activating the rotary motion of the transmission axis 109, leading to a higher power produced by the electric generator 102.

With reference to FIGS. 3 and 4, it is shown that said wind blades 112a, 112b, . . . , are bent, shaped and welded to said ogive 116, and they have a helical convex shape with the external profile inclined towards the inside of the turbine 107.

With reference to FIGS. 5a, 5b, 6a, 6b and 7, it is shown that said wind turbine 107 is composed of: a central union ogive 116 having height of 107.49 mm; on the ogive 116 a group of blades 112a, 112b, . . . , of a minimum number of 8, are welded; inside turbine 107, the height of the wind blades 112a, 112b, . . . , is 76.30 mm, and the front diameter is 189.20 mm.

Each of said wind blades 112a, 112b, . . . , of the turbine 107 has a helix convex shape, with a rectangular cross-section; the height of each wind blade can be in the range between 57.00 mm and 74.44 mm. The bend or maximum inclination of the superior blade is 95.25 degrees, instead the inferior inclination is of 126.86 degrees. The blade generates a distance of approximately 24.57 mm, along the bending profile, in respect to its longitudinal axis. The blade presents an inner and outer surface that is smooth. The larger and smaller sides of the rectangular surface of the blade, that are orientated towards the outer of the turbine, have an inclination going from the outside to the inside of the turbine, in order to better catch the air; the blades are welded to the ogive through a welding connection.

The wind generator 100 could further comprise: a cycles multiplier installed at the rotary axis 109 that connects the rotor of the electric generator 102. The above said wind turbine 107 is made of different possible materials, as: metal, carbon, plastic, or modern polymers. The wind generator 100 can further comprise sequential alternators and/or could include a three-phases alternator for heavy transportation means.

The wind generator 100 could be installed according to different configurations and systems for housing and positioning on the outer surfaces of the transportation means: front positioning, or lateral positioning, on the upper part, on the lower part, protruding in respect to the surface, or contained into the surface as an air opening.

The wind generator 100 could be installed in electric transportation means, where said transportation means would be represented by road vehicles, rail vehicles, water vehicles or air vehicles.

Said wind turbine 107 can be oriented, positioned and installed at the outer front or lateral surface of transportation means, being directed mainly to the direction of the incoming friction air, by using specific supporting means.

Therefore, the above examples show that the present invention reaches all the expected objectives. In particular, it permits to achieve a wind generator for transformation of kinetic energy of an air flow, moving in respect to the outer surface of transportation means, to kinetic energy of a rotating wind turbine having a horizontal axis, leading to a consequent transformation of kinetic energy to electric energy, by using an electric generator; the energy produced is available either to save electric energy (in batteries) and to provide propulsion of means (electric engines).

Further according to the invention, the device is composed of an innovative combination of:
some elements that are known from the state of the art, being of common use on the market: air conveyor or shell; ogive; electric generator; electric accumulator; electric connecting cables; anchorage supports,
and innovative and original elements: air conveyor comprising oval-shaped nozzles; turbine having a rotary horizontal axis; an innovative shape and conformation of the wind turbine blades; their innovative combination.

Furthermore, the device achieves the generation of a constant, continuous and potentially unlimited energy; the impact of air on the turbine that has been properly installed on the outer surface of the transportation mean (car vehicle, motor vehicle, bicycle, rail vehicle, water vehicle, air vehicle, etc.), by penetration of air into the air conveyor, causes a rotary motion of the turbine blades, producing a constant kinetic energy, that is transmitted to an electric generator, installed at the rear part of the general device.

Then, according to the invention, it is avoided the problem of interruption, discontinuity and insufficient production of energy, considering that the constant friction of air generated by the vehicle in motion activates the turbine according to a force that is proportional to the speed of the vehicle, and at the same time permits to achieve a significant energetic autonomy, either in propulsion and for other electric and/or electronic systems necessary for a proper functioning; Finally, according to the invention, the turbine presents a particular design and shape, and a strength of materials used to be constructed, so that to achieve a generation of kinetic energy as an effect of the rotary motion of the blades; in fact the efficiency of energy production in the wind generator depends on the characteristics in the turbine and, in particular, on the technical specifications of the blades belonging to the same turbine.

The present invention has been described by making reference to some non limiting examples and following some preferred embodiments; however it goes without saying that modifications and/or changes are possible. In example in the wind generator it is possible to change the geometrical shape, size and weight, of the whole object and/or its single components; either the wind generator and the turbine can be made of different types of material; the wind generator can be installed at different points and positions, having different configurations and on different surfaces and/or structures of the vehicle; size and shape of the turbine blades can change in size and material; the wind generator can be built including or not the electric generator; the wind generator can be built with or without power supply. Therefore, modifications and/or changes could be introduced by those skilled in the art without departing from the relevant scope, as defined in the enclosed claims.

1-11. (canceled)

12. An electric transportation means comprising a wind generator having a horizontal axis, said wind generator further comprising:
an air conveyor having a cylindrical shape that is empty inside, the air conveyor having oval-shaped nozzles on an outer surface thereof;
a horizontal wind turbine having a rotary group of wind blades fixed to a union ogive, said wind blades being bent, shaped, and welded to said ogive, said wind blades having a helical convex shape with an external profile inclined towards an inside of said wind turbine;
a transmission axis being rotatable and horizontal, wherein said wind turbine is installed with said ogive placed at a front part of said transmission axis, and wherein an electric generator is installed at a rear part of said transmission axis through a rotary element of said electric generator so that a rotation of the wind turbine is transmitted, through a rotation of the transmission axis, to the rotary element of the electric generator;
said electric generator comprises said rotary element and a fixed element that is connected to said wind turbine through said transmission axis, said electric generator is further connected to at least one external electric accumulator by at least one electric cable;
at least two ball bearings anchoring, through at least one connection element, said rotary transmission axis together either with said wind turbine and said electric generator, in a stable position inside said air conveyor, at the same time allowing rotary motion of said transmission axis on itself;
a cover closing said rear part of said air conveyor;
at least two supporting elements placed on said outer surface of said air conveyor in order to achieve an anchorage of said wind generator to the transportation means on which it is installed so that air flowing from a front part of said wind generator impacts said wind blades, forces said transmission axis to a rotary motion and therefore forces said rotary element of said electric generator to a rotary motion, thereby generating electric energy that is transmitted to said transportation means.

13. The electric transportation means according to claim 12, wherein said air conveyor has a cylindrical shape empty inside, and said air conveyor has a front opening and a rear opening, the front opening having a larger diameter than the rear opening, such that said air conveyor has a cone-shaped lateral surface and a profile decreasing in size from the front part to the rear part; and
wherein said wind blades have an outer profile bent towards said inside of said turbine, the rotary motion of said wind blades creating a path for the air entering into the wind generator and rotate on itself as a spiral in the longitudinal direction such that the air flowing as a spiral inside said wind generator is bounded by said lateral surface of said air conveyor, the air then being pressed along smaller spaces to increase the inner pressure thereof, and apply a force on said wind blades to activate the rotary motion of said transmission axis, thereby leading to a higher power produced by said electric generator.

14. The electric transportation means according to claim 13, wherein said air conveyor includes said oval-shaped nozzles having a two-dimensional shape that is elliptical and three dimensional conic, that can have different number and size, and can be placed in different positions according to specific needs; inside said conveyor, approximately in a middle of said cylindric surface, an element having 8 arms is installed that supports a central cylinder inside which said horizontal rotary axis with said turbine is installed.

15. The electric transportation means according to claim 14, wherein said wind turbine includes a central union ogive having a height of 107.49 mm; said ogive having a group of at least 8 blades welded thereto; inside said turbine the height of said wind blades is 76.30 mm, and the front diameter of said wind blades is 189.20 mm.

16. The electric transportation means according to claim 15, wherein each of said wind blades of said wind turbine has a helix convex shape and a rectangular cross-section, the height of each said wind blade is in the range between 57.00 mm and 74.44 mm, the bend or maximum inclination of a superior blade is 95.25 degrees, and the inferior inclination is of 126.86 degrees; the wind blades generate a distance of approximately 24.57 mm, along a bending profile, in respect to a longitudinal axis; the wind blades present an inner and outer surface that is smooth; the larger and smaller sides of the rectangular surface of the wind blade, that are orientated towards the outer of the wind turbine, have an inclination going from the outside to the inside of the wind turbine, in order to better catch the air; the wind blades are welded to the ogive through a welding connection.

17. The electric transportation means according to claim 16 including a cycles multiplier installed at said rotary axis that connects said rotor of said electric generator.

18. The electric transportation means according to claim 17, wherein said wind turbine comprises metal, carbon, plastic, modern polymers, or combinations thereof.

19. The electric transportation means according to claim 18, wherein said wind generator comprises a plurality of sequential alternators and/or includes a three-phase alternator for heavy transportation means.

20. The electric transportation means according to claim 19, wherein said wind generator is installed according to different configurations and systems for housing and positioning on the outer surfaces of the transportation means: front positioning, or lateral positioning, on the upper part, on the lower part, protruding in respect to the surface, or contained into the surface as an air opening.

21. The electric transportation means according to claim 20, wherein said transportation means are represented by road vehicles, rail vehicles, water vehicles or air vehicles.

22. The electric transportation means according to claim 21, wherein said wind turbine can be oriented, positioned and installed at the outer front or lateral surface of transportation means, being directed mainly to the direction of the incoming friction air, by using specific supporting means.
